(19) United States
(12) Patent Application Publication
(10) Pub. No.: US 2026/0364973 A1
(43) Pub. Date: Nov. 19, 2026

(54) Vehicle Salt Dispenser Device

(71) Applicant: Clifton Perry, Detroit, MI (US)

(72) Inventor: Clifton Perry, Detroit, MI (US)

(21) Appl. No.: 19/302,187

(22) Filed: Aug. 18, 2025

Related U.S. Application Data
(60) Provisional application No. 63/808,166, filed on May 19, 2025.

(51) Int. Cl. B60B 39/06; B60B 39/10

(52) U.S. Cl. CPC B60B 39/06; B60B 39/10

(57) ABSTRACT

A vehicle salt dispenser device is provided. The device is designed to enhance tire grip on roadways by dispensing road salt in front of and/or behind vehicle tires. The device can be either attached to or integrated into a vehicle and is comprised of at least one dispenser that can be secured near a vehicle tire. The dispenser is equipped with at least one motorized door, which can be operated by at least one control mechanism located inside the vehicle. This control can be a physical button, switch, or a digital touchscreen, allowing the door to open to varying degrees and release the salt compound onto the roadway in front of and/or behind at least one tire of the vehicle.

### CROSS-REFERENCE TO RELATED APPLICATION

The present application claims priority to, and the benefit of, U.S. Provisional Application No. 63/808,166, which was filed on May 19, 2025, and is incorporated herein by reference in its entirety.

### FIELD OF THE INVENTION

The present invention relates generally to the field of salt dispensers. More specifically, the present invention relates to a vehicle salt dispenser device that can be attached to and/or integrated into a vehicle such that the device dispenses road salt in front of and/or behind at least one vehicle tire to improve tire grip on a roadway. Accordingly, the present disclosure makes specific reference thereto. Nonetheless, it is to be appreciated that aspects of the present invention are also equally applicable to other like applications, devices, and methods of manufacture.

### BACKGROUND

Icy, snowy, and wet roads significantly increase the risk of vehicle accidents due to the reduced grip of vehicle tires on such surfaces. When roads are icy or covered in snow, the layer of ice or compacted snow creates a slippery surface, making it difficult for the tires to maintain traction. This lack of grip can lead to skidding, where the driver loses control of the vehicle's direction. Similarly, wet roads, often the result of rain or melting snow, can lead to hydroplaning, a condition where a layer of water builds up between the tires and the road surface. Hydroplaning effectively lifts the tires off the road, leading to a loss of traction and making it challenging to steer or brake the vehicle effectively. These conditions can drastically increase stopping distances, reduce the driver's control over the vehicle, and elevate the likelihood of accidents, including collisions with other vehicles or roadside objects.

Therefore, there exists a long-felt need in the art for a device that improves tire grip. There also exists a long-felt need in the art for a vehicle salt dispenser device that improves tire grip on icy, snowy, and wet roads. In addition, there exists a long-felt need in the art for a vehicle salt dispenser device that improves tire grip on icy, snowy, and wet roads wherein the device can be attached to and integrated within a vehicle.

The subject matter disclosed and claimed herein, in one embodiment thereof, comprises a vehicle salt dispenser device designed to enhance tire grip on roadways by dispensing road salt in front of and/or behind vehicle tires. The device can be either attached to or integrated into a vehicle and is comprised of at least one dispenser that can be secured near a vehicle tire. The dispenser is equipped with at least one motorized door, which can be operated by at least one control mechanism located inside the vehicle. This control can be a physical button, switch, or a digital touchscreen, allowing the door to open to varying degrees and release the salt compound onto the roadway in front of and/or behind at least one tire of the vehicle.

In this manner, the vehicle salt dispenser device of the present invention accomplishes all the forgoing objectives and provides a device that improves tire grip. More specifically, the device improves tire grip on icy, snowy, and wet roads. To do so, the device can be attached to and integrated within a vehicle wherein the device can remotely dispense road salt in front of and/or behind a vehicle tire.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle salt dispenser device comprised of at least one dispenser that can be secured to a portion of a vehicle near a vehicle tire. At least one control can be used to open at least one door of the dispenser to allow a road salt compound to fall from the dispenser onto a roadway to aid improve grip on a roadway.

The dispenser may be attached to and/or integrated within a frame, wheel well, etc. of a vehicle. The dispenser is preferably comprised of at least one motorized door that can be opened and shut via at least one control. The control may be in the form of a physical control (i.e., button, switch, etc.) or a digital touchscreen control that is preferably located in the interior of a vehicle. Once the door is opened via the control (wherein the control allows the door to open/close various amounts), at least one compound falls out of the dispenser through the door and onto a roadway area in front of and/or behind at least one tire of the vehicle (depending on the position of the dispenser). The compound is preferably a road salt but may be any granular compound capable of improved traction/grip of the tire on a roadway surface.

The present invention is also comprised of a method of using the device. First, a device is provided comprised of at least one control, at least one compound, and at least one dispenser attached to a vehicle, wherein the dispenser is positioned near a tire of the vehicle and wherein the dispenser is comprised of at least one motorized door. Then, a user can fill the dispenser with the compound and close the door of the dispenser via the control. Then, the user can open the door as needed (via the control) to provide grip in front of and/or behind the vehicle's tire via dispensing the compound out of the dispenser and onto the road surface below the tire.

Accordingly, the vehicle salt dispenser device of the present invention is particularly advantageous as it provides a device that improves tire grip. More specifically, the device improves tire grip on icy, snowy, and wet roads. To do so, the device can be attached to and integrated within a vehicle wherein the device can remotely dispense road salt in front of and/or behind a vehicle tire. In this manner, the vehicle salt dispenser device provides a solution to improving vehicle tire grip and safety given adverse road conditions.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one potential embodiment of a vehicle salt dispenser device of the present invention while attached to a vehicle in accordance with the disclosed architecture;

FIG. 2 illustrates a perspective view of a control of one potential embodiment of a vehicle salt dispenser device of the present invention in a vehicle interior in accordance with the disclosed architecture; and

FIG. 3 illustrates a flowchart of a method of using one potential embodiment of a vehicle salt dispenser device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that improves tire grip. There also exists a long-felt need in the art for a vehicle salt dispenser device that improves tire grip on icy, snowy, and wet roads. In addition, there exists a long-felt need in the art for a vehicle salt dispenser device that improves tire grip on icy, snowy, and wet roads wherein the device can be attached to and integrated within a vehicle.

The present invention, in one exemplary embodiment, is comprised of a vehicle salt dispenser device. The device is comprised of at least one dispenser. The dispenser can be secured to a portion of a vehicle near a vehicle tire wherein at least one control can be used to open at least one door of the dispenser to allow a road salt compound to fall from the dispenser onto a roadway to aid improve grip on a roadway.

The dispenser may be attached to and/or integrated within a frame, wheel well, etc. of a vehicle. The dispenser is preferably comprised of at least one motorized door that can be opened and shut via at least one control. The control may be in the form of a physical control (i.e., button, switch, etc.) or a digital touchscreen control that is preferably located in the interior of a vehicle. Once the door is opened via the control (wherein the control allows the door to open/close various amounts), at least one compound falls out of the dispenser through the door and onto a roadway area in front of and/or behind at least one tire of the vehicle (depending on the position of the dispenser). The compound is preferably a road salt but may be any granular compound capable of improved traction/grip of the tire on a roadway surface.

The present invention is also comprised of a method of using the device. First, a device is provided comprised of at least one control, at least one compound, and at least one dispenser attached to a vehicle, wherein the dispenser is positioned near a tire of the vehicle and wherein the dispenser is comprised of at least one motorized door. Then, a user can fill the dispenser with the compound and close the door of the dispenser via the control. Then, the user can open the door as needed (via the control) to provide grip in front of and/or behind the vehicle's tire via dispensing the compound out of the dispenser and onto the road surface below the tire.

Accordingly, the vehicle salt dispenser device of the present invention is particularly advantageous as it provides a device that improves tire grip. More specifically, the device improves tire grip on icy, snowy, and wet roads. To do so, the device can be attached to and integrated within a vehicle wherein the device can remotely dispense road salt in front of and/or behind a vehicle tire. In this manner, the vehicle salt dispenser device provides a solution to improving vehicle tire grip and safety given adverse road conditions.

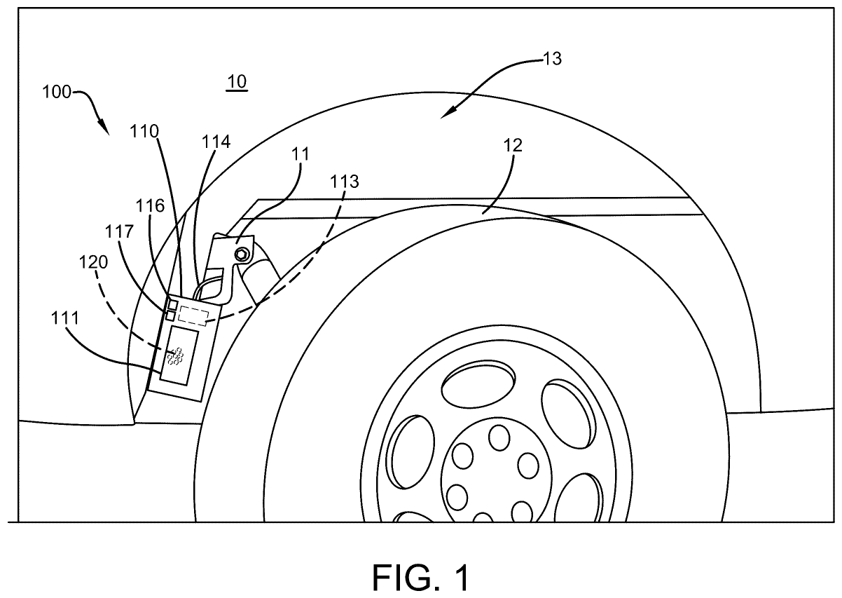

Referring initially to the drawings, FIG. 1 illustrates a side perspective view of one potential embodiment of a vehicle salt dispenser device 100 of the present invention while attached to a vehicle 10 in accordance with the disclosed architecture. The device 100 is comprised of at least one dispenser 110 that can be secured to a portion of a vehicle 10 near a vehicle tire 12. At least one control 130 can be used to open at least one door 111 of the dispenser 110 to allow a road salt compound 120 to fall from the dispenser 110 onto a roadway to aid improve grip on a roadway.

The dispenser 110 may be any size, shape and configuration in different embodiments. The dispenser 110 can be secured to a vehicle 10 via at least one fastener 117 such as but not limited to a mounting bracket, a bolt, a screw, etc. More specifically, the dispenser 110 may be attached to and/or integrated within a frame 11, wheel well 13, etc. of a vehicle 10.

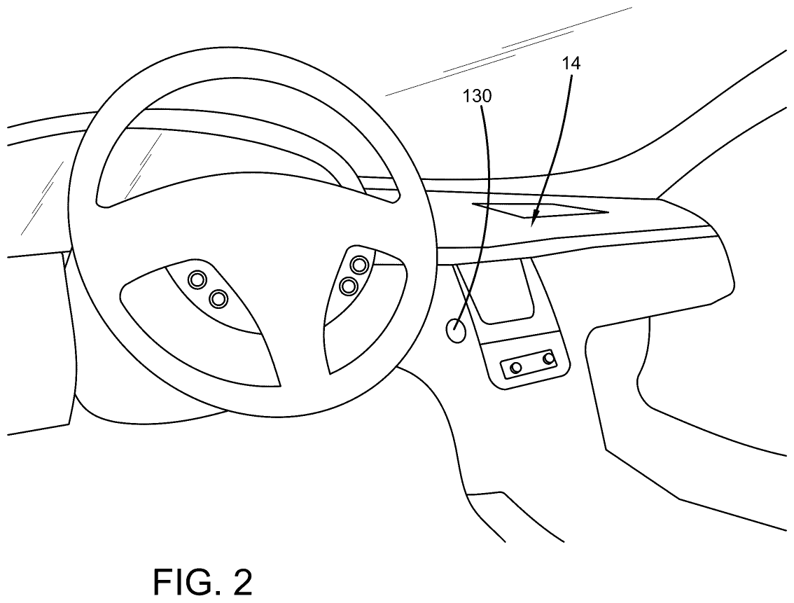

The dispenser 110 is preferably comprised of at least one motorized door 111. The door 111 can be opened and shut via at least one control 130. The control 130 may be in the form of a physical control (i.e., button, switch, etc.) or digital touch screen control that is preferably located in the interior 14 of a vehicle 10, as seen in FIG. 2. Once the door 111 is opened via the control 130 (wherein the control 130 allows the door 111 to open/close various amounts), at least one compound 120 falls out of the dispenser 110 through the door 111 and onto a roadway area in front of and/or behind at least one tire 12 of the vehicle (depending on the position of the dispenser 110). The compound 110 is preferably a road salt but may be any granular compound capable of improved traction/grip of the tire 12 on a roadway surface.

The door 111 receives power from at least one battery 113. The battery 113 preferably receives power from the vehicle's 10 existing power supply via at least one power wire 114. The wire also allows for wired communication between the door 111 and the control 130. In a different embodiment, the door 111 may be in wireless communication with the control 130 via at least one receiver 116 and/or at least one transmitter 117.

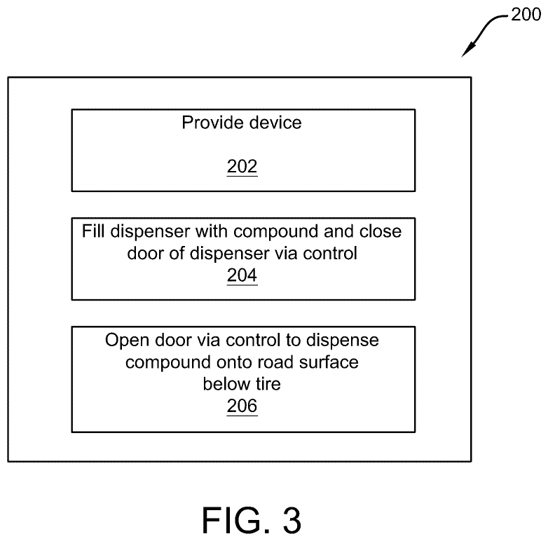

The present invention is also comprised of a method of using 200 the device 100, as seen in FIG. 3. First, a device 100 is provided comprised of at least one control 130, at least one compound 120, and at least one dispenser 110 attached to a vehicle 10, wherein the dispenser 110 is positioned near a tire 12 of the vehicle 10 and wherein the dispenser 110 is comprised of at least one motorized door 111[Step 202]. Then, a user can fill the dispenser 110 with the compound 120 and close the door 111 of the dispenser 110 via the control 130 [Step 204]. Then, the user can open the door 111 as needed (via the control 130) to provide grip in front of and/or behind the vehicle's tire 12 via dispensing the compound 120 out of the dispenser 110 and onto the road surface below the tire 12 [Step 206]. In an embodiment wherein one vehicle 10 has multiple devices 100, and each door 111 of each device 100 can be opened and/or closed individually or simultaneously.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle salt dispenser device” and “device” are interchangeable and refer to the vehicle salt dispenser device 100 of the present invention.

Notwithstanding the forgoing, the vehicle salt dispenser device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle salt dispenser device 100 as shown in the FIGS. are for illustrative purposes only, and that many other sizes and shapes of the vehicle salt dispenser device 100 are well within the scope of the present disclosure. Although the dimensions of the vehicle salt dispenser device 100 are important design parameters for user convenience, the vehicle salt dispenser device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle salt dispenser device comprising:
a dispenser comprised of a motorized door;
a control; and
a compound.

2. The vehicle salt dispenser device of claim 1, wherein the compound is positioned within the dispenser.

3. The vehicle salt dispenser device of claim 1, wherein the compound is comprised of a rock salt.

4. The vehicle salt dispenser device of claim 1, wherein the control opens the motorized door.

5. The vehicle salt dispenser device of claim 1, wherein the control closes the motorized door.

6. The vehicle salt dispenser device of claim 1, wherein the control is positioned in an interior of a vehicle.

7. The vehicle salt dispenser device of claim 1, wherein the control is comprised of a physical control.

8. The vehicle salt dispenser device of claim 1, wherein the control is comprised of a digital touch screen control.

9. A vehicle salt dispenser device comprising:
a dispenser comprised of a motorized door;
a control;
a battery;
a receiver; and
a compound.

10. The vehicle salt dispenser device of claim 9, wherein the compound is positioned within the dispenser.

11. The vehicle salt dispenser device of claim 9, wherein the compound is comprised of a rock salt.

12. The vehicle salt dispenser device of claim 9, wherein the control opens the motorized door.

13. The vehicle salt dispenser device of claim 9, wherein the control closes the motorized door.

14. The vehicle salt dispenser device of claim 9, wherein the control is positioned in an interior of a vehicle.

15. The vehicle salt dispenser device of claim 9, wherein the control is comprised of a physical control.

16. The vehicle salt dispenser device of claim 9, wherein the control is comprised of a digital touch screen control.

17. A method of using a vehicle salt dispenser device, the method comprising the following steps:
providing a vehicle salt dispenser device comprised of a control, a compound, and a dispenser attached to a vehicle, the dispenser positioned near a tire of the vehicle and wherein the dispenser is comprised of a motorized door;
filling the dispenser with the compound;
opening the door via the control;
closing the door via the control.

18. The method of using a vehicle salt dispenser device of claim 17, wherein the compound is comprised of a road salt.

19. The method of using a vehicle salt dispenser device of claim 17, wherein the control is comprised of a physical control.

20. The method of using a vehicle salt dispenser device of claim 17, wherein the control is comprised of a digital touch screen control.
